(19) United States
(12) Patent Application Publication
(10) Pub. No.: US 2026/0236766 A1
(43) Pub. Date: Aug. 13, 2026

(54) MACHINE LEARNING MODEL MONITORING WITH AUTOENCODER

(71) Applicant: TELEFONAKTIEBOLAGET LM ERICSSON (PUBL), STOCKHOLM (SE)

(72) Inventors: Yufei Blankenship, Centerville, VA (US); Zhan Zhang, Beijing (CN)

(21) Appl. No.: 19/159,246

(22) PCT Filed: Feb. 22, 2024
(86) PCT No.: PCT/IB2024/051720

§ 371 Date: Aug. 22, 2025

(30) Foreign Application Priority Data
Feb. 22, 2023 (WO) PCT/CN2023/077609

(51) Int. Cl. G06N 3/08; G06N 3/0455; H04W 24/08

(52) U.S. Cl. CPC G06N 3/08; G06N 3/0455; H04W 24/08

(57) ABSTRACT

In some embodiments, a method for a machine learning model monitoring in a cellular network includes: applying a machine learning model on data obtained to determine an operation status of an air interface between a user equipment (UE) and a network node; determining whether a model drifting of the machine learning model has occurred based on an autoencoder architecture that compares an input to an autoencoder and an output from the autoencoder during the application of the machine learning model; and causing retrain of the machine learning model upon a determination that the model drifting has occurred based on the autoencoder architecture.

### RELATED APPLICATIONS

This application claims the benefit of Patent Cooperation Treaty Application No. No. PCT/CN2023/077609, filed Feb. 22, 2023, the disclosure of which is hereby incorporated herein by reference in its entirety.

### TECHNICAL FIELD

Embodiments of the invention relate to the field of networking; and more specifically, to machine learning model monitoring with autoencoder used in a network.

### BACKGROUND

An air interface (also referred to as air-interface) is the wireless communication link between a mobile device (e.g., user equipment, UE) and an active base station through which the mobile device is coupled to a wireless network. The active base station can change as the user is on the move, with each changeover known as a handoff. The air interface is responsible for establishing and maintaining the wireless connection between the mobile device and the base station. The base station uses radio frequencies to transmit and receive signals with the mobile device over the air interface.

The air interface may support various wireless access technologies such as Universal Mobile Telecommunications System (UMTS), Long-Term Evolution (LTE), and 5G New Radio (NR). Each of these technologies uses different modulation schemes, frequency bands, and network architectures to provide high-speed data services to users. The air interface also includes several protocols and procedures to ensure secure and efficient communication between the mobile device and the wireless network. These protocols include authentication and encryption mechanisms to protect user data and prevent unauthorized access to the wireless network.

Artificial intelligence and machine learning (AI/ML) techniques may be used in a wireless network. For example, they may be used to enhance the performance and/or reduce complexity of the air interface in the wireless network. The machine learning models so used need to be monitored to detect model drifting. Model drifting is also known as concept drift, and it refers to the phenomenon where the statistical properties of the data that a machine learning model is trained on change over time, leading to a decline in the model's performance. In other words, model drifting occurs when the relationship between the input data and the output changes over time, making the model's predictions less accurate. This can happen for various reasons, such as changes in the data distribution, changes in the feature space, or changes in the target variable.

Model drifting is a common problem in machine learning, especially in real-world applications where the data can be dynamic and evolving. If left unaddressed, model drifting can lead to decreased accuracy, increased error rates, and degraded performance of the model. To address model drifting, various techniques can be used such as continuously monitoring the model's performance, updating the model's training data, adapting the model's parameters to the changing data distribution, or building ensemble models that combine multiple models trained on different time periods. It is essential to monitor for model drifting to ensure the accuracy of a machine learning model and its ongoing usefulness for decision-making.

Yet model monitoring to detect model drifting is challenging in a wireless network. For example, the ground truth labels are not readily available, and even when they are available, obtaining them incurs much delay and overhead.

### SUMMARY

Some general embodiments that address the problems of model drifting in wireless networks are summarized below.

In one embodiment, the problem is addressed by a method for a machine learning model monitoring in a cellular network. The method includes applying a machine learning model on data obtained to determine an operation status of an air interface between a user equipment (UE) and a network node, determining whether a model drifting of the machine learning model has occurred based on an autoencoder architecture that compares an input to an autoencoder and an output from the autoencoder during the application of the machine learning model, and causing retrain of the machine learning model upon a determination that the model drifting has occurred based on the autoencoder architecture.

Some related embodiments include one or more of the following features. The autoencoder architecture included an encoder to encode the data obtained to determine the operation status of the air interface and a decoder to decode output data from the encoder to reconstruct the data input to the encoder. A companion machine learning model is constructed for the machine learning model in the autoencoder architecture, wherein the companion machine learning model is applied to determine whether a model drifting has occurred. The companion machine learning model is a clone of the machine learning model. The companion machine learning model implements a decoder of the autoencoder architecture and the machine learning model implements an encoder of the autoencoder architecture.

In some embodiments, the encoder and decoder are trained during construction of the machine learning model. The encoder provides an output of the machine learning model upon the application of the machine learning model, and the output of the machine learning model is provided as an input to the decoder for determining whether the model drafting has occurred. Determining the operation status of the air interface includes identifying a set of position coordinates of the UE, and wherein a set of Reference Signal Received Power (RSRP) values as measured at a corresponding set of Transmit/Receive Points (TRPs). A first data set is obtained from comparing the input and output of the autoencoder during the application of the machine learning model, and a second data set is obtained from comparing the input and output of the autoencoder during training of the machine learning model, wherein the first and second data sets are compared to determine whether the model drafting has occurred.

A first data set is obtained from comparing the input and output of the autoencoder during the application of the machine learning model at a first time duration, and a second data set is obtained from comparing the input and output of the autoencoder during the application of the machine learning model at a second time duration. The first and second data sets are compared to determine whether the model drafting has occurred. A measurement of absolute difference between the first and second data sets is used to determine whether the model drafting has occurred. Distributions of the first and second data sets are compared to determine whether the model drafting has occurred. Comparing the distribution of the first and second data sets includes determining a probability density function (PDF) or cumulative distribution function (CDF)). Determining the operation status of the air interface comprises determining a time-of-arrival (ToA) of a radio signal, angle of arrival (AoA) of a radio signal, a reference signal received path power (RSRPP) received at the air interface. Monitoring the application of the machine learning model is performed by a user equipment or a network node.

Another general embodiment that addresses the problems includes a user equipment for a machine learning model monitoring in a cellular network. The user equipment includes processing circuitry and power supply circuitry configured to supply power to the processing circuitry. The processing circuitry of the user equipment is configured to applying a machine learning model on data obtained to determine an operation status of an air interface between a user equipment (UE) and a network node, determining whether a model drifting of the machine learning model has occurred based on an autoencoder architecture that compares an input to an autoencoder and an output from the autoencoder during the application of the machine learning model, and causing retrain of the machine learning model upon a determination that the model drifting has occurred based on the autoencoder architecture.

Another general embodiment that addresses the problems includes a network node for a machine learning model monitoring in a cellular network. The network node for machine learning model monitoring in a cellular network includes processing circuitry configured to perform related methods and power supply circuitry configured to supply power to the processing circuitry.

Another general embodiment includes a user equipment (UE) for a machine learning model monitoring in a cellular network. The UE includes an antenna configured to send and receive wireless signals, radio front-end circuitry connected to the antenna and to processing circuitry and configured to condition signals communicated between the antenna and the processing circuitry, the processing circuitry is configured to perform any of the steps of any of the related methods described herein, an input interface connected to the processing circuitry and configured to allow input of information into the UE to be processed by the processing circuitry, an output interface connected to the processing circuitry and configured to output information from the UE that has been processed by the processing circuitry, and a battery connected to the processing circuitry and configured to supply power to the UE.

Additional details are provided in the Detail Description and in the following drawings.

### BRIEF DESCRIPTION OF THE DRAWINGS

FIG. 1 illustrates the training and inference pipelines and their interactions within a model lifecycle management procedure according to some embodiments.

FIG. 2 illustrates inference of UE positions through a machine learning model according to some embodiments.

FIG. 3 illustrates inference of CSI data from UE positions through a machine learning model according to some embodiments.

FIG. 4 illustrates an autoencoder structure to monitor a machine learning model according to some embodiments.

FIG. 5 illustrates operations for a machine learning model monitoring in a cellular network to be performed in an electronic device according to some embodiments.

FIG. 6 illustrates an electronic device implementing adaptive fault remediation according to some embodiments.

FIG. 7 illustrates an example of a communication system according to some embodiments.

FIG. 8 illustrates a UE according to some embodiments.

FIG. 9 illustrates a network node according to some embodiments.

FIG. 10 is a block diagram of a host, which may be an embodiment of the host of FIG. 7, per various aspects described herein.

FIG. 11 is a block diagram illustrating a virtualization environment in which functions implemented by some embodiments may be virtualized.

FIG. 12 illustrates a communication diagram of a host communicating via a network node with a UE over a partially wireless connection according to some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### AI/ML for Physical Layer Functions

Artificial Intelligence (AI), Machine Learning (ML) have been investigated as promising tools to optimize the design of air interface in wireless communication networks in both academia and industry. Example use cases include using autoencoders for Channel State Information (CSI) compression to reduce the feedback overhead and improve channel prediction accuracy; using deep neural networks for classifying line-of-sight (LOS) and non-LOS (NLOS) conditions to enhance the positioning accuracy; and using reinforcement learning for beam selection at the network side and/or the UE side to reduce the signaling overhead and beam alignment latency; using deep reinforcement learning to learn an optimal precoding policy for complex Multiple Input Multiple Output (MIMO) precoding problems.

In the 3rd Generation Partnership Project (3GPP) new radio (NR) standardization work, there is a release-18 study item on artificial intelligence (AI) and/or machine learning (ML) for NR air interface starting in May 2022. This study item explores the benefits of augmenting the air interface with features enabling improved support of AI/ML based algorithms for enhanced performance and/or reduced complexity/overhead. Through studying a few selected use cases (channel state information (CSI) feedback, beam management and positioning), this disclosure (which may be presented as a 3GPP system information (SI)) aims at laying the foundation for future air interface use cases leveraging AI/ML techniques.

Building an AI/ML model includes several development steps where the actual training of the machine learning model is just one step in a training pipeline. An important part in AI/ML developing is the AI/ML model lifecycle management. Note that the terms of Artificial Intelligence (AI) model and Machine Learning (ML) model are used interchangeably herein to discuss the application of AI/ML on a communication system herein.

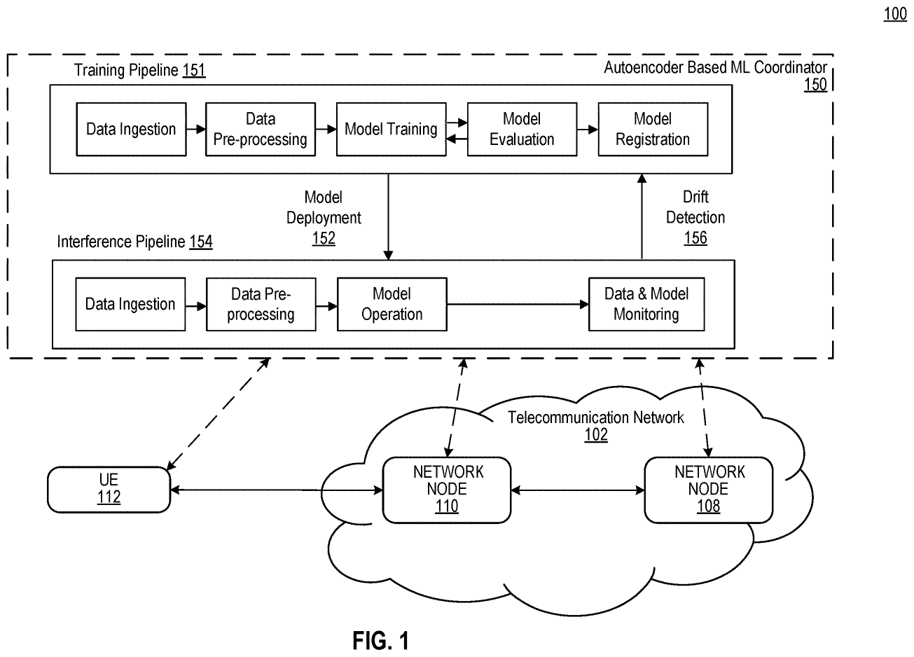

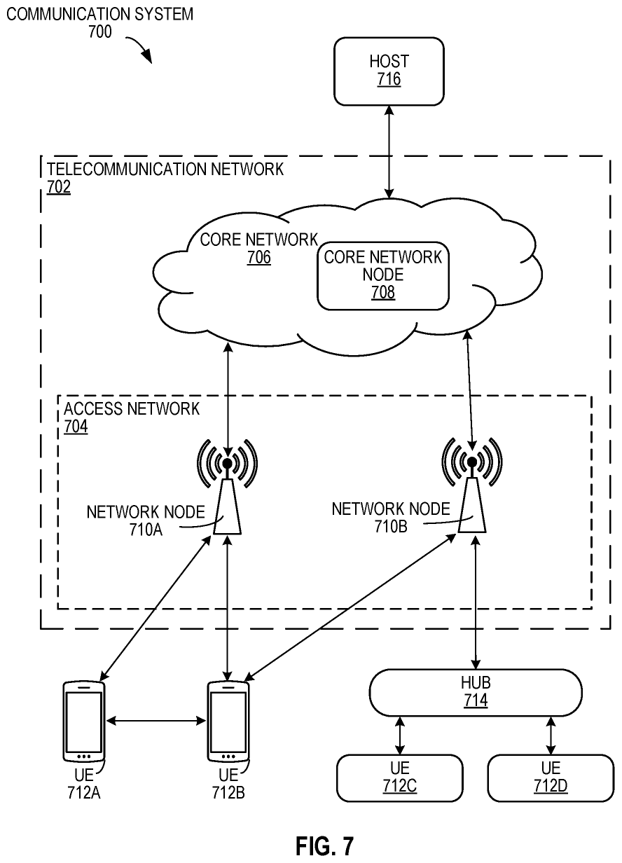

FIG. 1 illustrates the training and inference pipelines and their interactions within a model lifecycle management procedure in a communication system according to some embodiments. The communication system 100 includes UE 112 (among a set of UEs), a telecommunication network 102 that includes network nodes 110 and 128, and a machine learning coordinator 150. The communication system 100 is the same as or similar to the communication system 700, telecommunication network 102 is the same as or similar to the telecommunication network 702, and the network nodes 110 and 108 are the same as or similar to the network nodes 710A-710B and 708 respectively, as discussed in FIG. 7 herein.

The machine learning coordinator 150 manages the application of machine learning models to the communication system 100. The lifecycle management typically comprises of:
(1) A training (re-training) pipeline (at reference 151),

With data ingestion referring to gathering raw (training) data from a data storage. After data ingestion, there may also be a step that controls the validity of the gathered data.

With data pre-processing referring to some feature engineering applied to the gathered data, e.g., it may include data normalization and possibly a data transformation required for the input data to the AI/ML model.

With the actual model training steps as previously outlined.

With model evaluation referring to benchmarking the performance to some baseline. The iterative steps of model training and model evaluation continues until the acceptable level of performance (as previously exemplified) is achieved.

With model registration referring to register the AI/ML model, including any corresponding AI/ML-meta data that provides information on how the AI/ML model was developed, and possibly AI/ML model evaluations performance outcomes.
(2) A deployment stage (at reference 152) to make the trained (or re-trained) AI/ML model part of the inference pipeline.
(3) An interference pipeline (at reference 154), which is the process of using a trained machine learning model to make predictions or decisions on new data. The interference pipeline includes the following modules/logic:
(i) Data ingestion referring to gathering raw (inference) data from a data storage;
(ii) Data pre-processing stage that is typically identical to corresponding processing that occurs in the training pipeline;
(iii) Model operational referring to using the trained and deployed model in an operational mode; and
(iv) Data & model monitoring referring to validate that the inference data are from a distribution that aligns well with the training data, as well as monitoring model outputs for detecting any performance, or operational, drifts.
(4) A drift detection function (at reference 156) informs about any drifts in the model operations, as illustrated in FIG. 1.

The machine learning coordinator 150 may be implemented using an autoencoder according to some embodiments, and the autoencoder based machine learning is discussed in further detail herein below.

The AI/ML modeling in the communication system 100 may be used in multiple scenarios. For example, in a first scenario, we assume that AI/ML models operating with the existing standard air interface are placed at the UE side. For example, UE 112 may use the one or more AI/ML models from machine learning coordinator 150 to generate output that is reported to a centralized node (e.g., network node 108) in the network 102 for positioning the UE location.

In a second scenario, we assume AI/ML models operating with the existing standard air interface are placed at different Transmit/Receive Points (TRPs). A TRP is a location within a network where the transmission and reception of wireless signals takes place, and it may be a point at which a base station communicates with a UE or another base station/network node. For example, network node 124 may have one or more TRPs to communicate with UE 112. A TRP uses the AI/ML models from machine learning coordinator 150 to generate output that is reported to the centralized node in the network 102 for positioning the UE location.

### Models Obtained Using the Autoencoder Structure

Autoencoders (AEs) are useful architectures for unsupervised learning and semi-supervised learning. An autoencoder is trained on a set of input data by passing it through a series of hidden layers that progressively reduce the dimensionality of the data. The output layer of the autoencoder then reconstructs the original input data from the compressed representation, which is known as the latent space. During training, the autoencoder attempts to minimize the difference between the original input data and the reconstructed output data. This is typically done using a loss function, such as mean squared error, that measures the difference between the two. Once the autoencoder is trained, the compressed representation in the latent space can be used for a variety of tasks, such as data compression, anomaly detection, or feature extraction for use in supervised learning tasks.

Conceptionally, AEs have two main components according to some embodiments: (i) the encoder g(·), and (ii) the decoder f(·). The encoder maps the input data X to the hidden state h (or called coded information), the decoder strives to map h back to X. When training the AE, the goal is to achieve as much as possible: decoder output \hat{X}=encoder input X. In other words:

The encoder function can be described as: g(X)=h,

The decoder function can be described as: f(h)=\hat{X}.

The autoencoder structure can be applied to the use case of UE positioning, when there is no or very few labelled training data. In the following, the fingerprinting-based positioning method with the auto-encoder structure is described.

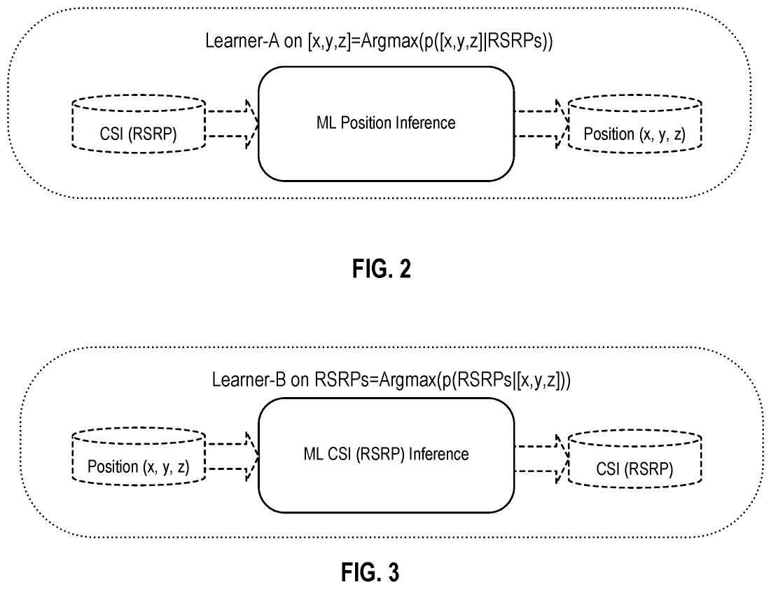

A fingerprinting-based positioning method refers to exploiting a computing graph where the model inference is the UE's coordinates [x, y, z]. FIG. 2 illustrates inference of UE positions from CSI data through a machine learning model according to some embodiments.

As illustrated in FIG. 2, the learner-A could build a computing graph according to some embodiments to infer a position coordinate [x, y, z], which corresponds to a Reference Signal Received Power (RSRP) vector measurement by multiple TRPs.

Conversely, it is also possible to build a reverse ML function that maps a position [x, y, z] to a RSRP vector. FIG. 3 illustrates inference of CSI data from UE positions through a machine learning model according to some embodiments. As illustrated, with a same data set of CSI (RSRP vector) and its corresponding position coordinate, a second model could be learned according to some embodiments to infer CSI (RSRP vector) corresponding to a position coordinate [x, y, z].

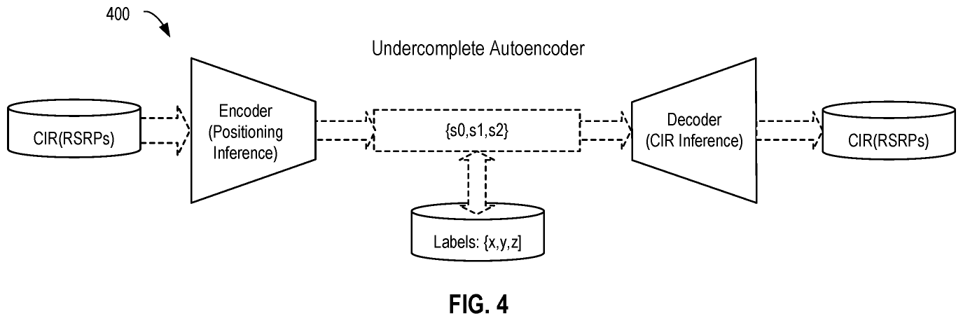

Therefore, the first estimator (inferring position coordinates) and second estimator (inferring CSI (RSRP vector)) could be connected sequentially as an autoencoder, in which the encoder is a position estimator while the decoder is a CIR (RSRP vector) estimator, owing to their converse relationship of input and output variables. The dimension of position coordinate vector (e.g., 3) is much smaller than the RSRP vector (e.g., 18 TRPs), hence, this autoencoder structure becomes an undercomplete autoencoder, which helps to conduct a semi-supervised learning. FIG. 4 illustrates an autoencoder structure 400 to monitor a machine learning model according to some embodiments. The monitor of the machine learning model may observe model drifting, which results in the retraining of the machine learning model.

Note that CIR (Channel Impulse Response) inference refers to the process of estimating the channel impulse response of a wireless communication channel based on received signals. The channel impulse response is a time-domain representation of the frequency-selective characteristics of a communication channel, which describes how the channel affects the transmitted signal. The CIR inference algorithm is used to estimate this response from the received signal, by analyzing the time and frequency characteristics of the signal. In wireless communication systems (e.g., communication system 100), the CIR is an important parameter for signal processing and channel equalization, as it provides information about the multipath propagation, time dispersion, and frequency-selective fading effects of the channel. By estimating the CIR, the receiver can compensate for the channel distortion and improve the quality and reliability of the received signal. CIR inference is a key technique in many 3GPP radio access technologies, such as GSM, UMTS, and LTE, and is used in various applications, such as channel estimation, equalization, and interference suppression.

### Model Monitoring Introduction

The methods for model monitoring generally belong to two categories: (a) performance-based, i.e., examining a certain quality metrics of the model output (e.g., inference accuracy, error rate, system performance); (b) data distribution based, i.e., monitoring whether the model input distribution has drifted, or whether the model output distribution has drifted.

Performance-based methods are more reliable, easier to implement, and less prone to the problem of false alarm. However, performance-based methods typically assume that ground truth label is somehow made available during model operation, so that the ground truth label can be compared with the model output during deployment to determine whether the deployed model is still working properly. However, it is rarely the case that ground truth label can be obtained during model deployment; and even if that is possible, it typically incurs much delay and overhead.

Below this is illustrated in more details using the AI/ML use case of UE positioning.

With supervised methods, existing solutions require the system (either the UE or the network) to acquire a second position estimate from a different source to compare with the primary positioning estimate. For instance, for UE ML-model for positioning, the UE may use another positioning method to verify the positioning accuracy of the ML model from time to time. In one example, positioning based on non-radio access technology (RAT) information can be used, if the UE has access to non-RAT signal such as GNSS, WiFi, Bluetooth, camera, sensor. The UE can for example trigger a request to perform a UE ML-model verification upon retrieving its position via a non-RAT signal GNSS, WiFi, Bluetooth, camera, sensor.

However, such second source position estimate may not always be feasible. For instance, GNSS cannot be used in indoor environments. WiFi and Bluetooth may not be used in sensitive industrial environments to avoid interference or eavesdropping.

Furthermore, even when a second source position estimate is available, it is not clear which of the primary and second position estimates is less accurate. In fact, if the second position estimate is assumed to be always more accurate than the primary position estimate, then the system should discard the primary position estimation solution and adopt only the second position estimation solution.

In unsupervised or statistical methods, existing solutions can detect if a potential change in the system has occurred but, in some cases, the change does not translate in a loss of performance in the monitored model, thus triggering retraining solely on this information can end-up being wasteful.

Thus, a reliable method is needed to determine whether the operating environment is still consistent with the characteristics of the environment from which training data were collected for training the AI/ML models. It is also a requirement that such reliable method does not require an external source to provide the ground truth of model output during model operation.

### Autoencoder Based Model Monitoring

Embodiments of this invention thus propose solutions to monitor the performance of AI/ML models when the AI/ML model is trained via one or more autoencoders (AEs). For example, the model shift is monitored by comparing the input to an auto-encoder with the output of the auto-decoder during model deployment.

In some embodiments, monitoring the performance of AI/ML models is performed through comparing statistics of generated data at decoder against the input data. Two methods are discussed as examples: a) a predefined model-driven method, which uses a mathematical derivation based stochastic processing detector; b) a data driven method, which uses an machine learning model dominant processing-based detector. For example, the predefined model-driven method may use a statistical mean of a random variable, a function of covariance of a random matrix variable, or another formula specified a man-made model (in contrast to machine learning model from data).

The advantages of these methods include that they may be executed by the same entity that performs model inference, i.e., without relying on other entities to perform monitoring for itself, if the machine learning model to be monitored is in an autoencoder architecture. Additionally, these proposed methods can be flexibly deployed at either network side or UE-side. Generally, it can be used to support various AI/ML functionalities, e.g., positioning, beam management, mobility management, link adaption, etc.

### AI Model Drifts and Inputs for Monitoring Function

Machine learning (ML) model drift refers to the phenomenon that a model's performance on input data at model deployment stage is degraded from the expected performance when the model was trained with a training dataset.

Essentially, due to certain reasons, if the condition probability of input/output p(y|x) inherent in the data set is changed, where x is the input data and y is the label, the machine learning model shaped by this relationship of datasets at training will degrade in its performance.

Model drift may occur due to various reasons. Typical reasons include one or more of the following: poor quality/distorted training data or online operational data, changing environments. While the issue of poor training data can be remediated with careful data collection, changing environments are unavoidable and can't be controlled. Changing environments, such as mobile objects roaming at the scene or displacement of certain objects, may cause the change in input data statistics, and the relationship between model input data and expected model output data. Additionally, interferences happen at data collection or device malfunction in collecting the data will also impair the data statistics and the conditional probabilities among data point and labels or among the elements of data points.

The training dataset is composed of collected historical data, which carries inherent relationships about the data for the model to learn. When the model is deployed in a dynamically changing environment in the real world, over time the statistical properties of the data encountered at model deployment may shift from those at training phase. This may lead to the problem that the model can no longer produce accurate output as it was trained for. Without model adaptation, the machine learning model in production thus slowly deteriorates over time. Therefore, there is a need to continuously perform model monitoring during deployment. A drift indicator is triggered if model drift is detected according to certain criteria, indicating unexpected or unacceptable model performance. Then appropriate reactions can be taken when a drift indicator is received, for example, re-training the model or deactivate the model. This helps to secure the service integrity remarkably.

In this disclosure, methods are provided to perform model monitoring by employing autoencoder (AEs) architecture.

### Model Monitoring According to Some Embodiments

For machine learning models for estimating either positioning values or other parameters, it is proposed to employ an autoencoder architecture to conduct the model drift monitoring. The autoencoder architecture may be implemented through the autoencoder based machine learning coordinator 150 discussed herein above.

For example, for each machine learning model, a companion machine learning model is constructed or the machine learning model itself is borrowed, to be used to monitor its possible performance drift. An AI model operates a network node/UE for a certain task. Its companion model is a model drift monitoring model to monitor this AI model. A companion model could have a clone of the model monitored as a part and have metric calculation part to form a detection function. However, cloning might not be feasible sometimes.

In general, autoencoder can be used for a model to function (performing inference, e.g., obtaining UE position coordinates from RSRP vector measurement) at the network to sometimes, in which case the monitoring function should clone the autoencoder and use it for further processing: detection of model drift. Yet when a model to be monitored does not have such an architecture always at its training phase, monitoring function will train a decoder by regarding the model monitored as an encoder to build an autoencoder.

Thus, an autoencoder architecture may be chosen and a monitoring machine learning model to be built for monitoring. Hence, a decoder could be trained along with an encoder (e.g., AI inference monitored) either at the training of machine learning model construction or at the model drift monitoring phase.

In some cases, autoencoder scheme is used for monitored machine learning model itself. In such a case, model monitoring function could make a direct use of this trained autoencoder to monitor the model drift. In some embodiments, a machine learning model may be trained at semi-supervised learning.

For example, semi-supervised learning with an autoencoder can be used for positioning. The input X to the encoder can be set to a list of L RSRP values as measured at L TRPs. The latent variable h at the out of the encoder is the UE location. The output of the decoder, X is mapped back to the list of L RSRP values as in X. Thus, if RSRP values observed at 18 TRPs are used as X, then both X and X are a vector of 18 real values (RSRP). The list of RSRP values at the input to the Encoder and the list of reconstructed RSRP at the output of the Decoder are expected to be very close, since this was the goal at the training stage. In this proposal, this characteristic can be used to perform model monitoring.

Note that in the discussion above, it was assumed that RSRP values are used as input. It is understood by those skilled in the art that other measurements that are useful for determining UE locations can be used instead. For example, time-of-arrival (ToA), angle of arrival (AoA), reference signal received path power (RSRPP), etc. It is also understood that the same methodology can be applied at the UE side or network side at a network node (e.g., network node 110 or 108).

### Detection Metric

Considering the property of autoencoders, the distance calculation can be expressed as the following formula: dₜ=distance (Xₜ, \hat{X}ₜ). The distance calculation needs to reflect the element-by-element comparison of the two length-L vectors, Xₜ and \hat{X}ₜ, since ideally Xₜ=\hat{X}ₜ element-by-element.

If the model is working well for the deployed environment, then a distance metric at time t between the encoder input Xₜ and decoder output \hat{X}ₜ is expected to be small and comparable to the values at training phase. Note that one typical metric is dₜ=statistical mean of the Euclidean distance between Xₜ, \hat{X}ₜ. If that metric is chosen for monitoring the drift, it should be at a small difference to the reference value at the training phase. If the mean at operation is larger than the mean at training by a threshold value, that indicates a possible model drift.

In general, if the autoencoder continues to work well in the deployed environment, then dₜ is expected to be small (almost) all the time and its distribution matches that at training, indicating that decoder output \hat{X}ₜ is able to closely match the encoder input Xₜ.

The input-output distances of AE among two data sets (one at training, another at operation) can use various methods to reflect their deviations. For example, two sets of distances may be obtained:

Firstly, test set of distances. For a given time tⱼ in the size-T time window, tᵢ≤tⱼ≤t_{i+T-1}, the distance dₜ_{ⱼ} is calculated to obtain the test set. The test set is the set of distances that is under examination by the model monitoring function, {dₜ_{ᵢ}, dₜ_{ᵢ₊₁}, . . . , dₜ_{_{i+T−1}}}.

Secondly, reference set of distances. The reference set

$$\{ {d}_{{t}_{i}}^{ref} , {d}_{{t}_{i + 1}}^{ref} , … , {d}_{{t}_{i + T - 1}}^{ref} \} .$$

is typically obtained from the training dataset when the auto-encoder was trained. Alternatively, the reference set

$$\{ {d}_{{t}_{i}}^{ref} , {d}_{{t}_{i + 1}}^{ref} , … , {d}_{{t}_{i + T - 1}}^{ref} \}$$

is obtained from an earlier time window of model deployment, for which the set of distances of the autoencoder is stored. For example, the reference set is obtained from a historical period where the deployed model was working properly. If the data that the model works on has seasonality (e.g., a pattern that repeats approximately daily/weekly/monthly/annually/etc.), the reference time window should be chosen to contain data of similar distribution as the test time window, e.g., same hour of the day, same day of the week, etc.

When there is no model drifting, the test set {dₜ_{ᵢ}, dₜ_{ᵢ₊₁}, . . . , dₜ_{_{i+T−1}}} shares the same/similar statistical distribution as the reference set

$$\{ {d}_{{t}_{i}}^{ref} , {d}_{{t}_{i + 1}}^{ref} , … , {d}_{{t}_{i + T - 1}}^{ref} \} .$$

To quantify the similarity or dissimilarity of the two sets of distances, a variety of metrics other than aforementioned ones can be devised as well:
(1) A simple model monitoring metric can be the difference of mean values of the test set and the reference set of distances, μ_{diff}=|μ_{ref}−μₜₑₛₜ|, where

$${μ}_{test} = E ( \{ {d}_{{t}_{i}} , {d}_{{t}_{i + 1}} , … , {d}_{{t}_{i + T - 1}} \} ) , {μ}_{ref} = E ( \{ {d}_{{t}_{i}}^{ref} , {d}_{{t}_{i + 1}}^{ref} , … , {d}_{{t}_{i + T - 1}}^{ref} \} ) .$$

Then μ_{diff} is compared with a threshold to determine whether model drift is detected. Let the threshold be f×σ_{ref}, where σ_{ref} is the standard deviation of the reference set

$$\{ {d}_{{t}_{i}}^{ref} , {d}_{{t}_{i + 1}}^{ref} , … , {d}_{{t}_{i + T - 1}}^{ref} \} .$$

Then model drift is detected if |μ_{ref}−μₜₑₛₜ|>f×σ_{ref}; otherwise, no drift is detected. f is a parameter selected for the desired model monitoring sensitivity. A typical value can be f=3.0.
(2) To have a rigorous model monitoring metric, the statistics of the test set {dₜ_{ᵢ}, dₜ_{ᵢ₊₁}, . . . , dₜ_{_{i+T−1}}} can be compared with the reference statistics of

$$\{ {d}_{{t}_{i}}^{ref} , {d}_{{t}_{i + 1}}^{ref} , … , {d}_{{t}_{i + T - 1}}^{ref} \} ,$$

and the distribution should be very similar and pass the statistical test (e.g., pass Kolmogorov-Smirnov test (K-S test or KS test)) of

$$\{ {d}_{{t}_{i}} , {d}_{{t}_{i + 1}} , … , {d}_{{t}_{i + T - 1}} \} and \{ {d}_{{t}_{i}}^{ref} , {d}_{{t}_{i + 1}}^{ref} , … , {d}_{{t}_{i + T - 1}}^{ref} \} .$$

Note that the reference statistics (e.g., probability density function (PDF) or cumulative distribution function (CDF)) of

$$\{ {d}_{{t}_{i}}^{ref} , {d}_{{t}_{i + 1}}^{ref} , … , {d}_{{t}_{i + T - 1}}^{ref} \}$$

can be obtained from the training dataset (with both labeled and unlabeled data). Alternatively, the reference statistics (e.g., PDF or CDF) of

$$\{ {d}_{{t}_{i}}^{ref} , {d}_{{t}_{i + 1}}^{ref} , … , {d}_{{t}_{i + T - 1}}^{ref} \}$$

can be obtained from an earlier time window when the model was verified to work well or training data set of the model to be monitored.
(3) The Kullback-Leibler (KL) divergence calculation between PDF of

$$\{ {d}_{{t}_{i}}^{ref} , {d}_{{t}_{i + 1}}^{ref} , … , {d}_{{t}_{i + T - 1}}^{ref} \}$$

at training and PDF of at {dₜ_{ᵢ}, dₜ_{ᵢ₊₁}, . . . , dₜ_{_{i+T−1}}} operations. As described earlier, the distance da is the distance between (X_{*}, \hat{X}_{*}). After obtaining the two sets of d_{*} over a time window, the statistical distribution of d_{*} at operation can be estimated and compared with a reference statistical distribution at training.
(4) Jensen-Shannon (JS) divergence between PDF of

$$\{ {d}_{{t}_{i}}^{ref} , {d}_{{t}_{i + 1}}^{ref} , … , {d}_{{t}_{i + T - 1}}^{ref} \}$$

at training and PDF of at {dₜ_{ᵢ}, dₜ_{ᵢ₊₁}, . . . , dₜ_{_{i+T−1}}} operations.

Generally, if the model is not appropriate for the deployed environment anymore, then dₜ=distance (Xₜ, \hat{X}ₜ) is expected to be large, and have a different PDF/CDF as

$$\{ {d}_{{t}_{i}}^{ref} , {d}_{{t}_{i + 1}}^{ref} , … , {d}_{{t}_{i + T - 1}}^{ref} \} .$$

When applying KS test or entropy-based comparison against a certain threshold, the test should reject the hypothesis that “{dₜ_{ᵢ}, dₜ_{ᵢ₊₁}, . . . , dₜ_{_{i+T−1}}} samples and

$$\{ {d}_{{t}_{i}}^{ref} , {d}_{{t}_{i + 1}}^{ref} , … , {d}_{{t}_{i + T - 1}}^{ref} \}$$

samples come from the same distribution”. In such as case, an alarming message is triggered and sent out by the model drift monitoring function.

Another solution is that putting output estimation data from the decoder to the encoder to get a second estimates of the encoded information, a distance measure could be done at this 2^{nd} estimated codes (hidden states) and 1^{st} encoded codes. Usually, autoencoder has a squeezed dimension at the code info space, such as comparison could be in a reduced dimension.

Singular values of covariance of generated data and input data could be used for comparison, if the distance of singular value vectors is greater than a predefined threshold, an alarm could trigger, given same space-spanning vectors are used.

Combination of aforementioned metrics could jointly be used to format a joint metric to detect the model drift.

### Implementation Considerations

Several factors may be considered in implementing the autoencoder for model monitoring:
(1) If the machine learning model to be monitored does not have an autoencoder architecture, the machine learning model could be borrowed to the monitoring function as an encoder, the monitoring function will train a decoder to match it. Note that the machine learning model to be monitored may be regarded as an encoder (inference net), and embodiments may train a decoder model (net) to build the autoencoder architecture. Inference net is a general terminology for an AI model trained to infer some parameters of the network.
(2) If the machine learning model to be monitored is in an autoencoder network. It could be directly used for aforementioned model drift monitoring. Or, to reduce the complexity of monitoring, a student network could be trained according to the teacher network. The student network has a lower performance but with a higher computational efficiency comparing to the teacher network. The model to be monitored could be teacher network. And a reduced complexity student network could serve for monitoring.
(3) The input size to the Encoder and the output size at the Decoder are usually high. Methods are thus needed to reduce the size of input and output. In one example, principal component analysis (PCA) is applied. In another method, domain knowledge is applied to select the most important features for model monitoring.

### Operations According to Some Embodiments

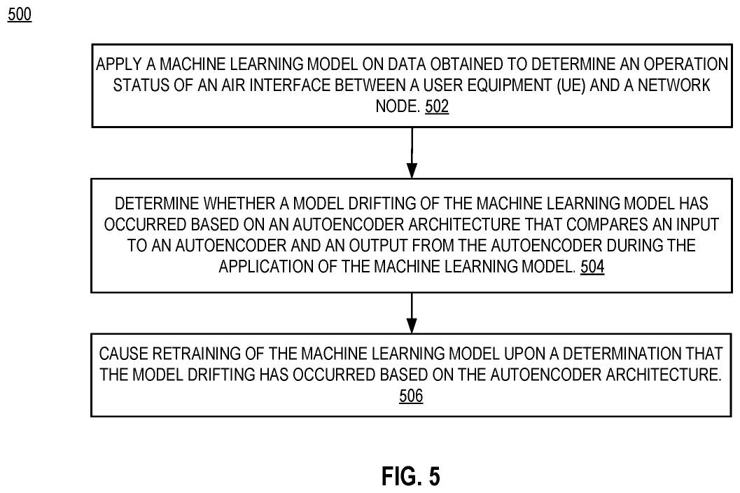

FIG. 5 illustrates operations for a machine learning model monitoring in a cellular network to be performed in an electronic device according to some embodiments. The electronic device may be a UE (e.g., UE112) or a network node (e.g., network node 110 or 108).

At reference 502, a machine learning model is applied on data obtained to determine an operation status of an air interface between a user equipment (UE) and a network node. At reference 504, it is determined whether a model drifting of the machine learning model has occurred based on an autoencoder architecture that compares an input to an autoencoder and an output from the autoencoder during the application of the machine learning model. At reference 506, retraining of the machine learning model is caused upon a determination that the model drifting has occurred based on the autoencoder architecture. For example, the electronic device (e.g., UE 112 or network node 110) may report to a centralized node (e.g., network node 108 in the network 102) to retrain the machine learning model.

In some embodiments, the autoencoder architecture comprises an encoder to encode the data obtained to determine the operation status of the air interface, and a decoder to decode output data from the encoder to reconstruct the data input to the encoder.

In some embodiments, a companion machine learning model is constructed for the machine learning model in the autoencoder architecture, wherein the companion machine learning model is applied to determine whether a model drifting has occurred.

In some embodiments, the companion machine learning model is a clone of the machine learning model. In some embodiments, the companion machine learning model implements a decoder of the autoencoder architecture and the machine learning model implements an encoder of the autoencoder architecture.

In some embodiments, the encoder and decoder are trained during construction of the machine learning model.

In some embodiments, the encoder provides an output of the machine learning model upon the application of the machine learning model, and wherein the output of the machine learning model is provided as an input to the decoder for determining whether the model drafting has occurred.

In some embodiments, determining the operation status of the air interface comprises identifying a set of position coordinates of the UE, and wherein a set of Reference Signal Received Power (RSRP) values as measured at a corresponding set of Transmit/Receive Points (TRPs).

In some embodiments, a first data set is obtained from comparing the input and output of the autoencoder during the application of the machine learning model, and a second data set is obtained from comparing the input and output of the autoencoder during training of the machine learning model, wherein the first and second data sets are compared to determine whether the model drafting has occurred.

In some embodiments, a first data set is obtained from comparing the input and output of the autoencoder during the application of the machine learning model at a first time duration, and a second data set is obtained from comparing the input and output of the autoencoder during the application of the machine learning model at a second time duration, wherein the first and second data sets are compared to determine whether the model drafting has occurred.

In some embodiments, a measurement of absolute difference between the first and second data sets is used to determine whether the model drafting has occurred.

In some embodiments, distributions of the first and second data sets are compared to determine whether the model drafting has occurred.

In some embodiments, comparing the distribution of the first and second data sets comprises determining a probability density function (PDF) or cumulative distribution function (CDF)).

In some embodiments, determining the operation status of the air interface comprises determining a time-of-arrival (ToA) of a radio signal, angle of arrival (AoA) of a radio signal, a reference signal received path power (RSRPP) received at the air interface.

### Devices and Systems Implementing Embodiments of the Invention

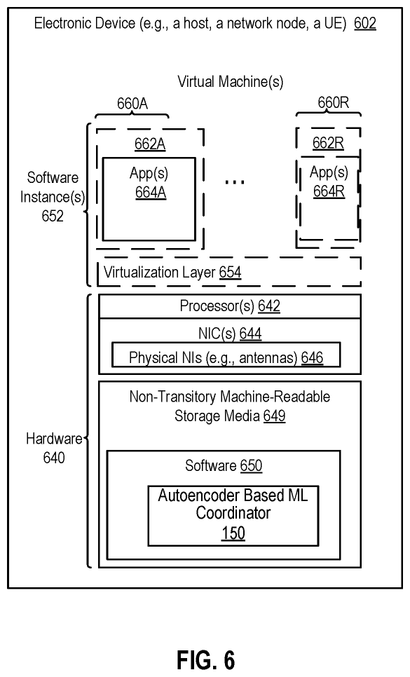

FIG. 6 illustrates an electronic device implementing machine learning model monitoring with autoencoder according to some embodiments. The electronic device may be a host in a cloud system, or a network node/UE in a wireless/wireline network, and the operating environment and further embodiments the host, the network node, the UE are discussed in more details herein below. The electronic device 602 may be implemented using custom application-specific integrated-circuits (ASICs) as processors and a special-purpose operating system (OS), or common off-the-shelf (COTS) processors and a standard OS. In some embodiments, the electronic device 602 implements an autoencoder based machine learning coordinator 150.

The electronic device 602 includes hardware 640 comprising a set of one or more processors 642 (which are typically COTS processors or processor cores or ASICs) and physical NIs 646, as well as non-transitory machine-readable storage media 649 having stored therein software 650. During operation, the one or more processors 642 may execute the software 650 to instantiate one or more sets of one or more applications 664A-R. While one embodiment does not implement virtualization, alternative embodiments may use different forms of virtualization. For example, in one such alternative embodiment, the virtualization layer 654 represents the kernel of an operating system (or a shim executing on a base operating system) that allows for the creation of multiple instances 662A-R called software containers that may each be used to execute one (or more) of the sets of applications 664A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 654 represents a hypervisor (sometimes referred to as a virtual machine monitor (VMM)) or a hypervisor executing on top of a host operating system, and each of the sets of applications 664A-R run on top of a guest operating system within an instance 662A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels, and sets of applications that are run in different software containers).

The software 650 contains autoencoder based machine learning coordinator 150 that performs operations described with reference to operations as discussed relating to FIGS. 1 to 4. The autoencoder based machine learning coordinator 150 may be instantiated within the applications 664A-R. The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual electronic device 660A-R.

A network interface (NI) may be physical or virtual. In the context of IP, an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 644. The physical network interface 646 may include one or more antenna of the electronic device 602. An antenna port may or may not correspond to a physical antenna. The antenna comprises one or more radio interfaces.

### a Wireless Network According to Some Embodiments

FIG. 7 illustrates an example of a communication system 700 according to some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

### UE According to Some Embodiments

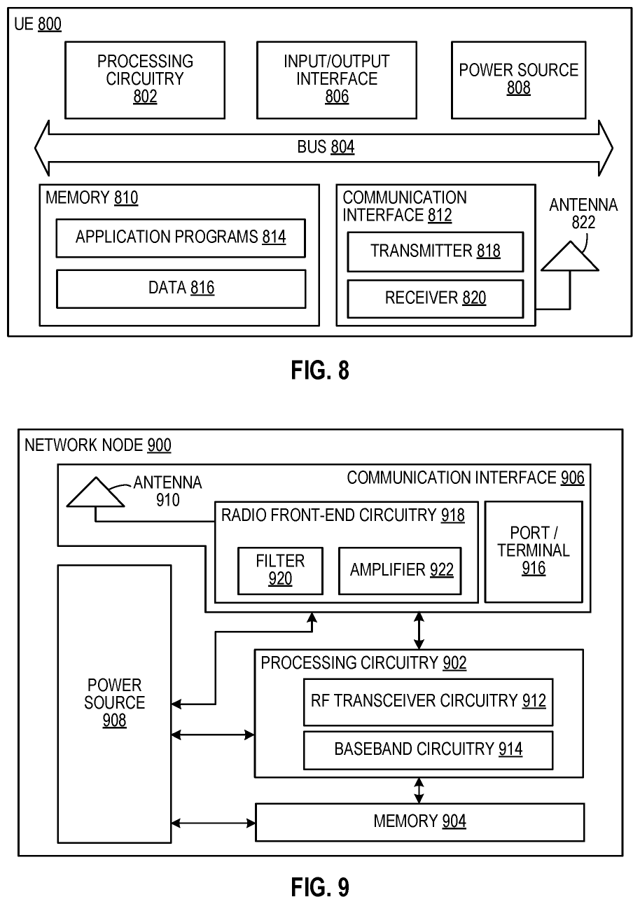

FIG. 8 illustrates a UE 800 according to some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node According to Some Embodiments

FIG. 9 illustrates a network node 900 according to some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

### Host According to Some Embodiments

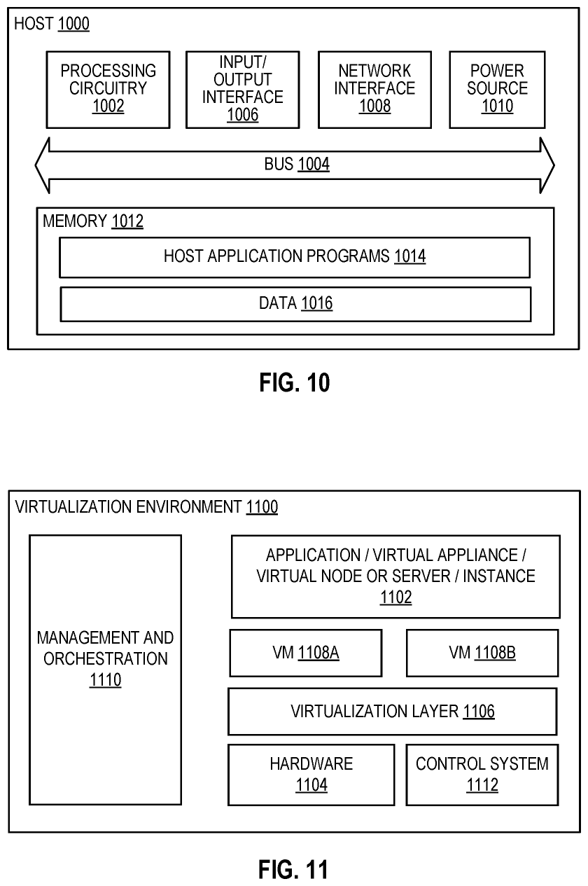

FIG. 10 is a block diagram of a host 1000, which may be an embodiment of the host 716 of FIG. 7, per various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment According to Some Embodiments

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment 1100 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

### Communication Among Host, Network Node, and UE According to Some Embodiments

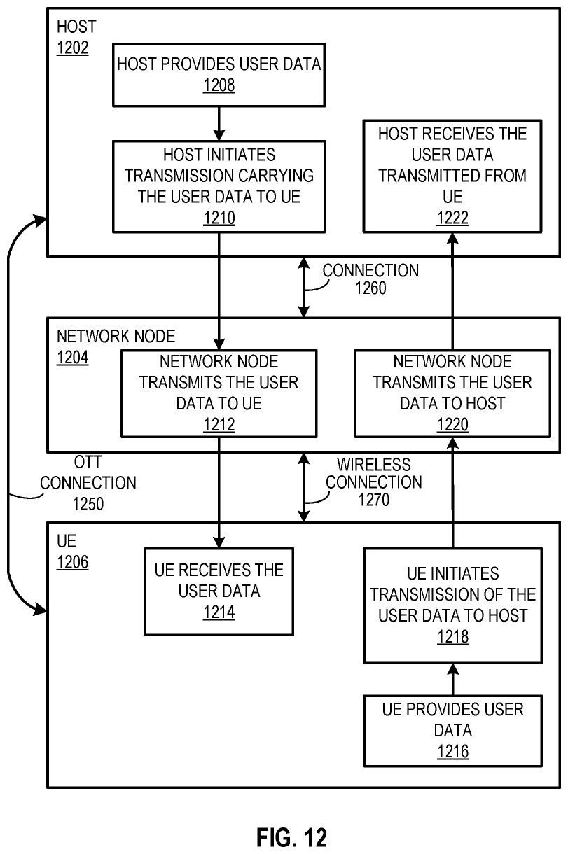

FIG. 12 illustrates a communication diagram of a host 1202 communicating via a network node 1204 with a UE 1206 over a partially wireless connection according to some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein, can refer to any whole number of items including one item.

An electronic device (such as the electronic device 602) stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method for a machine learning model monitoring in a cellular network, comprising:
applying a machine learning model on data obtained to determine an operation status of an air interface between a user equipment (UE) and a network node;
determining whether a model drifting of the machine learning model has occurred based on an autoencoder architecture that compares an input to an autoencoder and an output from the autoencoder during the application of the machine learning model; and
causing retraining of the machine learning model upon a determination that the model drifting has occurred based on the autoencoder architecture.

2. The method of claim 1, wherein the autoencoder architecture comprises an encoder to encode the data obtained to determine the operation status of the air interface, and a decoder to decode output data from the encoder to reconstruct the data input to the encoder.

3. The method of claim 1, wherein a companion machine learning model is constructed for the machine learning model in the autoencoder architecture, wherein the companion machine learning model is applied to determine whether a model drifting has occurred.

4. The method of claim 3, wherein the companion machine learning model is a clone of the machine learning model.

5. The method of claim 3, wherein the companion machine learning model implements a decoder of the autoencoder architecture and the machine learning model implements an encoder of the autoencoder architecture.

6. The method of claim 1, wherein the encoder and decoder are trained during construction of the machine learning model.

7. The method of claim 1, wherein the encoder provides an output of the machine learning model upon the application of the machine learning model, and wherein the output of the machine learning model is provided as an input to the decoder for determining whether the model drafting has occurred.

8. The method of claim 1, wherein determining the operation status of the air interface comprises identifying a set of position coordinates of the UE, and wherein a set of Reference Signal Received Power (RSRP) values as measured at a corresponding set of Transmit/Receive Points (TRPs).

9. The method of claim 1, wherein a first data set is obtained from comparing the input and output of the autoencoder during the application of the machine learning model, and a second data set is obtained from comparing the input and output of the autoencoder during training of the machine learning model, wherein the first and second data sets are compared to determine whether the model drafting has occurred.

10. The method of claim 1, wherein a first data set is obtained from comparing the input and output of the autoencoder during the application of the machine learning model at a first time duration, and a second data set is obtained from comparing the input and output of the autoencoder during the application of the machine learning model at a second time duration, wherein the first and second data sets are compared to determine whether the model drafting has occurred.

11. The method of claim 1, wherein a measurement of absolute difference between the first and second data sets is used to determine whether the model drafting has occurred.

12. The method of claim 1, where distributions of the first and second data sets are compared to determine whether the model drafting has occurred.

13. The method of claim 1, wherein comparing the distribution of the first and second data sets comprises determining a probability density function (PDF) or cumulative distribution function (CDF).

14. The method of claim 1, wherein determining the operation status of the air interface comprises determining a time-of-arrival (ToA) of a radio signal, angle of arrival (AoA) of a radio signal, a reference signal received path power (RSRPP) received at the air interface.

15. The method of claim 1, wherein monitoring the application of the machine learning model is performed by a user equipment or a network node.

16. A user equipment for a machine learning model monitoring in a cellular network, comprising:
processing circuitry configured to perform operations comprising:
applying a machine learning model on data obtained to determine an operation status of an air interface between a user equipment (UE) and a network node;
determining whether a model drifting of the machine learning model has occurred based on an autoencoder architecture that compares an input to an autoencoder and an output from the autoencoder during the application of the machine learning model; and
causing retraining of the machine learning model upon a determination that the model drifting has occurred based on the autoencoder architecture; and
power supply circuitry configured to supply power to the processing circuitry.

17. (canceled)

18. A network node for a machine learning model monitoring in a cellular network, the network node comprising:
processing circuitry configured to perform operations comprising:
applying a machine learning model on data obtained to determine an operation status of an air interface between a user equipment (UE) and a network node;
determining whether a model drifting of the machine learning model has occurred based on an autoencoder architecture that compares an input to an autoencoder and an output from the autoencoder during the application of the machine learning model; and
causing retraining of the machine learning model upon a determination that the model drifting has occurred based on the autoencoder architecture; and
power supply circuitry configured to supply power to the processing circuitry.

19-23. (canceled)

24. The network node of claim 18, wherein the autoencoder architecture comprises an encoder to encode the data obtained to determine the operation status of the air interface, and a decoder to decode output data from the encoder to reconstruct the data input to the encoder.

25. The network node of claim 18, wherein a companion machine learning model is constructed for the machine learning model in the autoencoder architecture, wherein the companion machine learning model is applied to determine whether a model drifting has occurred.

26. The network node of claim 18, wherein the companion machine learning model is a clone of the machine learning model.

27. The network node of claim 18, wherein the companion machine learning model implements a decoder of the autoencoder architecture and the machine learning model implements an encoder of the autoencoder architecture.

28. The network node of claim 18, wherein the encoder and decoder are trained during construction of the machine learning model.
